(19) United States
(12) Patent Application Publication
(10) Pub. No.: US 2016/0186816 A1
(43) Pub. Date: Jun. 30, 2016

(54) ELASTIC COUPLING DEVICE FOR CONNECTING TWO DRIVE SHAFTS

(71) Applicant: IFC COMPOSITE GMBH, Haldensleben (DE)

(72) Inventors: Matthias Voigt, Hohe Boerde OT Brumby (DE); Dirk Neyer, Buelstringen (DE)

(21) Appl. No.: 15/064,836

(22) Filed: Mar. 9, 2016

Related U.S. Application Data
(63) Continuation of application No. PCT/DE2014/000423, filed on Aug. 20, 2014.

(30) Foreign Application Priority Data
Sep. 9, 2013 (DE) 102013014971.1

(51) Int. Cl. F16D 3/78

(52) U.S. Cl. CPC F16D 3/78

(57) ABSTRACT

The invention relates to an elastic coupling device for connecting two drive shafts to a coupling disk, which is arranged axially between a first drive shaft and a second drive shaft and is arranged against the first drive shaft and the second drive shaft in a rotationally fixed manner. The coupling disk acts as a mechanical compensator during torque transmission between the two drive shafts. The coupling disk is retained without penetration by means of a plurality of circumferentially distributed clamping pieces, which are or can be connected to the first drive shaft and to the second drive shaft in circumferential alternation. The coupling disk and the clamping pieces are contoured in an axis-of-rotation direction in such a way that the clamping pieces encompass the coupling disk in a form-closed manner, wherein the form closure is effective in a rotational direction.

### CROSS REFERENCE TO RELATED APPLICATIONS

This application is a continuation of International Application No. PCT/DE2014/000423 filed Aug. 20, 2014 which claims the benefit of German Application No. 102013014971.1 filed Sep. 9, 2013, both of which are hereby incorporated by reference.

### BACKGROUND

The present invention relates to an elastic coupling device for connecting two drive shafts in accordance with the following disclosure, drawings and claims.

Non-disengageable coupling devices of this kind are used in Cardan shafts of motor vehicles or agricultural and industrial machines for connecting two adjacent shaft segments to one another, for example. Their essential functional component is an elastic coupling element which is capable of compensating for slight misalignments of the shaft segments and of damping load surges which occur during starting or during rapid changes in engine speed. Such coupling elements are known as flexible disks or as Hardy disks, after the inventor named in GB 497 903 A.

GB 497 903 A shows an elastic flexible or Hardy disk produced from rubber for connecting two drive shafts, which have a plurality of circumferentially distributed bushings through which screw bolts can be passed. Force is introduced into a flexible disk of this kind by screwing the bushings to the two drive shafts by means of a plurality of bolts aligned parallel to the axis, wherein one bushing is connected to one drive shaft and the circumferentially following bushing is connected to the other drive shaft in alternation.

DE 10 2010 053 691 A1 discloses an elastic coupling device for connecting two drive shafts, in which an elastic coupling element has arms that are swept in the manner of a ship's propeller and extend from radially inside to radially outside. The arms are arranged in a manner symmetrically distributed over the circumference of the coupling element in one radial plane or in two radial planes lying one above the other in the axial direction. Arranged in the region of the radially outer end of each arm there is an axially aligned opening for the passage of a connecting element or of a screw bolt. The connecting elements can be connected alternately to a free end of the first drive shaft and a free end of the second drive shaft. The coupling element can be produced from rubber, from a fiber composite material or from metal, wherein the swept arms have a relatively high elasticity.

Given this background situation, it is the underlying object of the present invention, as shown by the examplary embodiment(s), to provide an elastic coupling device for connecting two drive shafts which is of simple and light design, economical to produce and durable and robust in operation.

This object is achieved by means of the features disclosed and described herein, including advantageous embodiments and developments of the present invention as found in the claims.

The present invention is based on the insight that, in the case of an elastic coupling or flexible disk for producing a torque-transmitting connection between two drive shafts with a slight axial or angular misalignment relative to one another, the introduction of holes or punched features can have a negative effect on the elasticity properties and durability of the disk in a manner which is undefined and possibly varies over the time in operation. This applies especially when the coupling or flexible disk is produced from a lightweight fiber composite material. In contrast, positive fastening of the coupling disk between the two drive shafts ensures that reliable torque transmission while compensating misalignments is possible by means of simple design measures without penetrating the coupling disk in a damaging way or otherwise changing the properties of the coupling disk in a harmful way.

### SUMMARY

The present invention starts from an elastic coupling device for connecting two drive shafts, having a coupling disk, which is arranged axially between and for conjoint rotation on a first drive shaft and a second drive shaft, wherein the coupling disk acts as a mechanical compensator during torque transmission between the two drive shafts. To achieve the stated object, the invention furthermore envisages that the coupling disk is retained without penetration by means of a plurality of circumferentially distributed mounting pieces, that the mounting pieces can be connected to the first drive shaft or to the second drive shaft in circumferential alternation, that the coupling disk and the mounting pieces are contoured parallel to the direction of the axis of rotation of the coupling disk in such a way that the mounting pieces fit at least partially positively around the coupling disk on respectively associated coupling sections, and that the positive engagement is effective in the direction of rotation of the coupling disk.

By means of this arrangement, an elastic coupling device for connecting two drive shafts with a possible axial or angular misalignment is made available, with which the driving forces are passed through a coupling disk without the need to introduce fastening openings into the coupling disk to achieve this. Moreover, no bushings or the like are introduced into the coupling disk to reinforce the fastening openings and enable bolts to be passed through.

According to one embodiment of the present invention, provision can be made for the mounting pieces to be designed as clamping elements, which can be pushed into positive engagement on the coupling disk in a preloaded manner. Accordingly, the coupling disk is mounted in mounting pieces and is fastened between the two drive shafts by means of the mounting pieces. This fastening can be achieved with little effort and at low cost. In interaction with the mounting pieces, the mounting of the coupling disk ensures that power transmission between the two drive shafts is achieved without disrupting or interrupting the disk structure. By means of positive engagement between the coupling disk and the mounting pieces, said engagement being effective in the direction of rotation of the drive shafts and in the direction of rotation of the coupling device, the device is secured against twisting or spinning and can also reliably transmit relatively high torques which may act on the coupling device owing to high loads or steep engine speed gradients.

Moreover, provision can be made for the coupling disk to be produced as a monolithic component composed of a fiber composite material. The coupling disk composed of the fiber composite material can have a defined fiber orientation. For example, the fiber orientation is chosen so that the fibers in the coupling disk are arranged substantially in a circular or spiral pattern.

Fiber composite materials are available in many forms, including glass fibers, carbon fibers, ceramic fibers, synthetic fibers or even fibers composed of renewable raw materials, and they can be produced in virtually any desired geometrical shape. As is known, fiber composite materials consist of a supporting matrix and fibers arranged therein, which impart a high strength with a relatively very low weight to the respective body. The elasticity properties of such a component are both material- and direction-dependent. The coupling disk is preferably monolithic, i.e. manufactured from a single piece. Alternatively, however, the coupling disk can also be constructed from a plurality of assembled individual parts.

A coupling disk which is particularly well-suited to the coupling device according to the invention can be produced from a joint-free component composed of a fiber reinforced plastic, for example, which is produced in an injection molding process or in a laminating process. A coupling disk of this kind is particularly light and can compensate an angular misalignment in a range of from 2 to 5 degrees, and it can thus replace a complex Cardan joint in the case of misalignments of this order of magnitude.

It is possible to selectively define a main fiber direction in the disk production process in order to establish or at least reinforce particular elasticity properties of the disk. Ideally, the disk should be designed for a predetermined maximum stress in the direction of the plane of the disk and for a predetermined maximum bending moment in the direction of the plane of the normal to the disk through the interaction of material selection, disk dimensions and fiber orientation.

In the case of a coupling disk composed of a fiber composite material, the supporting matrix and reinforcing fibers thereof are, according to the invention, not pierced in a damaging way or otherwise exposed to damage. Potential weak points in the disk, such as openings or notches, at which moisture, oil or dirt could enter the coupling disk, are thus eliminated. As a result, the coupling disk composed of fiber composite material is capable of bearing particularly high loads and the properties are also maintained according to the specifications thereof, even after a long time in operation.

According to a preferred embodiment of the present invention, provision can be made for the coupling disk to be designed as an annular disk, for the mounting pieces to be distributed in a circumferentially symmetrical manner and to be capable of being pushed into positive engagement on the coupling disk alternately from radially inside to radially outside and from radially outside to radially inside, for the mounting pieces each substantially to comprise two plates in the form of ring segments, which are arranged opposite one another on both sides of the coupling disk and are connected to one another to form a U-shaped component formed so as to be solid or integral at one end radially on the outside of the coupling disk. The respective connection of two contoured plates to give a mounting piece can be achieved by welding, adhesive bonding, screw fastening, riveting and/or flanging. Integral production of the mounting pieces is also possible.

Accordingly, the annular disk geometry makes it possible to attach clamps or clamping elements which are closed at one end both to the outer circumference and to the inner circumference of the coupling disk. Balanced distribution of the clamping or mounting forces both in the radial direction of the disk and in the circumferential direction is thereby achieved. Moreover, the coupling device can accommodate a centering aid in a central opening of the coupling disk, if required.

By way of example, six mounting pieces are arranged on the coupling disk in a circumferentially distributed manner. In such an arrangement, one mounting piece in each case preferably fits around the coupling disk from radially inside to radially outside and the circumferentially following mounting piece fits around it from radially outside to radially inside in alternation. It would also be possible for two circumferentially directly adjacent mounting pieces in each case to fit around the coupling disk from radially inside to radially outside and two circumferentially following, directly adjacent mounting pieces to fit around the coupling disk from radially outside to radially inside.

To connect the coupling disk or mounting pieces between which the coupling disk is mounted to a free end or a flange of the first drive shaft and to a free end or a flange of the second drive shaft, provision can be made for a flange-type or stud-type portion to be formed in each case in the region of the radially outer end of the mounting piece, at least on one of the sides facing the drive shafts, on which portion a connecting element, such as a stud bolt or a machine screw, can be directly secured or can be inserted or screwed non-rotatably into a corresponding recess or threaded hole. It is preferred if one mounting piece in each case is connected for conjoint rotation to one drive shaft and the circumferentially following mounting piece is connected for conjoint rotation to the other drive shaft in alternation. Particularly uniform introduction of power into the disk is thereby achieved.

To achieve the positive engagement between the coupling disk and the mounting pieces, provision can be made for the coupling disk to be of corrugated design, at least in the region of the mounting pieces, and for the mounting pieces to be each of correspondingly corrugated design and to be capable of being connected positively to the corrugated coupling disk on their surfaces facing the axial surfaces of the coupling disk.

Conventional coupling disks composed of rubber or of a rubber-elastic material have a certain elasticity simply by virtue of the material. In the case of coupling disks composed of metal, a spring action can be achieved by means of appropriate spring-type shaping. A disk composed of a fiber composite material can intrinsically have elastic material properties to compensate for a slight axial misalignment or angular misalignment of the two drive shafts to be connected. However, a corrugated geometry imparts to the fiber composite disk a spring property which, in particular, makes it easier to compensate for flexing torsional vibrations during torque transmission from the first drive shaft, via the disk, to the second drive shaft, wherein corresponding force vectors act on the relevant corrugation flanks in the circumferential direction or direction of rotation of the coupling device.

Accordingly, the coupling disk can have alternating axial bulges emerging from the plane of the disk, at least in the regions in which positive engagement is supposed to be established by means of the mounting pieces. However, corrugation which is formed over the entire disk circumference is also possible. The coupling disk can be designed as a corrugated annular disk of fiber-reinforced plastic, for example. Accordingly, the corrugation of the coupling disk can be limited to corresponding elevations and/or depressions on the axial surfaces of the coupling disk or can entirely traverse the coupling disk axially.

In principle, other positive connections between the coupling disk and the mounting pieces are also possible. For example, spherical bulges, which project axially from the plane of the disk and are formed in a manner distributed in the circumferential direction and in the radial direction on the coupling disk, and corresponding bulges formed on the mounting pieces can form positive engagement elements.

Provision can furthermore be made for the mounting pieces to be produced from a lightweight material. The mounting pieces can be produced from a fiber-reinforced plastic, for example, in the case of a coupling device designed in accordance with the invention for transmitting relatively low torques, for instance. Stud bolts made of metal or metallic threaded sleeves for receiving fastening screws are then laminated into these mounting pieces. It is thereby possible to reduce the weight of the coupling device further. Of course, it is also possible to use conventional mounting pieces or clamping elements composed of a metallic material.

Provision can furthermore be made for an elastically deformable interlayer in each case to be arranged axially between the mounting pieces and the coupling disk. Accordingly, the coupling disk is mounted with the interposition of rubber mats, a silicone layer or the like in the region of the mounting pieces, for example. The surface of the coupling disk is thereby particularly well protected with respect to the mounting pieces. The interlayer furthermore acts as a shock-damping layer and reinforces the vibration-damping effect on the coupling device. The interlayer can also further increase the elasticity of the coupling device. As an alternative, it is also possible for simple, thick protective sheets to be placed between the mounting pieces and the coupling disk.

### BRIEF DESCRIPTION OF THE DRAWINGS

To further clarify the present invention, drawings of an illustrative embodiment are provided.

FIG. 1 is a perspective view of an elastic coupling device according to the present invention.

FIG. 2 is a perspective view of a coupling disk of a coupling device according to FIG. 1.

FIG. 3 is a longitudinal section view of the FIG. 1 coupling device.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

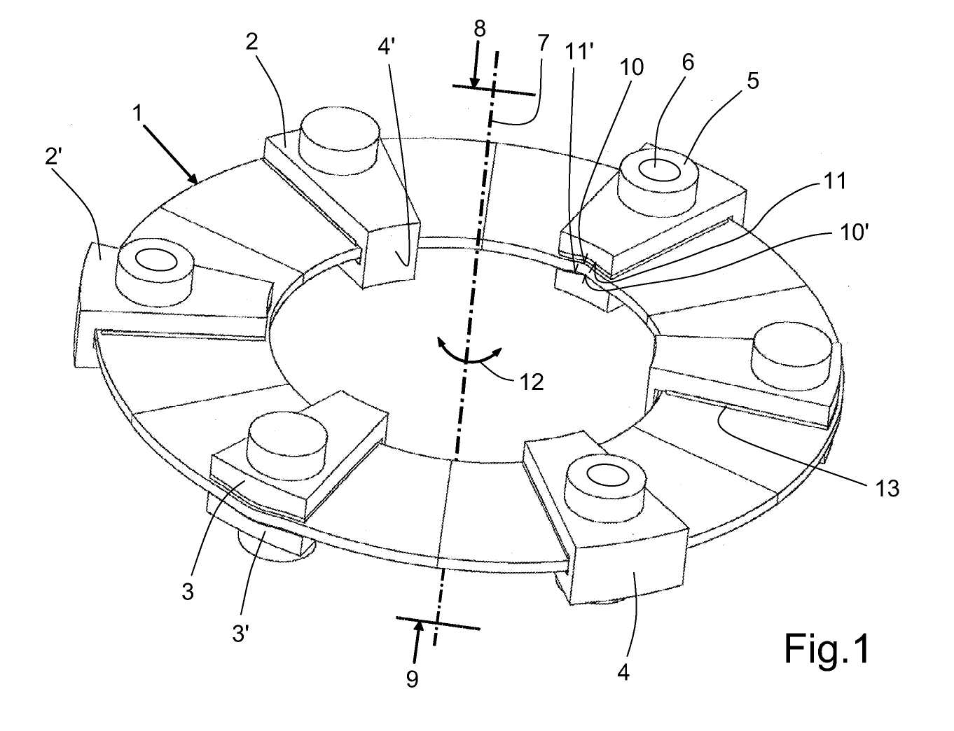

The elastic coupling device shown in FIG. 1 has a coupling disk 1, which is mounted in six mounting pieces 2, 2′ arranged in a manner distributed symmetrically over the circumference. The coupling device is used for the elastic connection of two drive shafts 8, 9, indicated only symbolically, e.g. two shaft segments of a Cardan shaft of a motor vehicle, wherein slight misalignment between the shaft segments are to be compensated by the elasticity of the connection.

The coupling disk 1 is designed as an annular disk and is produced from a fiber-reinforced plastic as an integral component. The mounting pieces 2, 2′ are designed as U-shaped clamping elements, which fit around the coupling disk 1. Each of these mounting pieces 2, 2′ comprises two plates 3, 3′ in the form of a ring segment, which lie opposite one another on the axial sides of the coupling disk 1 and are connected rigidly to one another at one end 4, 4′ radially to the outside of the coupling disk 1. Three mounting pieces 2 are closed radially to the outside of the inner circumference of the coupling disk 1. The three other mounting pieces 2′ are closed radially to the outside of the outer circumference of the coupling disk 1. The six mounting pieces 2, 2′ are pushed onto the coupling disk 1 in circumferential alternation from radially inside to radially outside and from radially outside to radially inside with positive engagement and under preload. A rubber-elastic interlayer 13 which protects the material is in each case placed between the mounting pieces 2, 2′ and the coupling disk 1.

In the region of its radially outer end, each mounting piece 2, 2′ has a reinforced flange portion 5, which is rigidly connected to the respectively associated plate 3, 3′. The flange portions 5 are designed as cylindrical stud projections. In the case of three mounting pieces 2′, threaded holes 6 for receiving three stud bolts (not shown) are introduced into the stud projections 5. The three other mounting pieces 2 arranged therebetween in the circumferential direction have corresponding threaded holes for receiving three further stud bolts on the underside of the coupling disk, which is not visible in FIG. 1.

To produce a connection for conjoint rotation between the two drive shafts 8, 9, the stud bolts are screwed into the threaded holes on both sides of the coupling disk 1 and are screwed by means of their free ends into a flange disk or the like (not shown) on the free end of the adjacent first drive shaft 8 or second drive shaft 9 respectively. The screwed joints are formed in circumferential alternation, wherein in each case one mounting piece 2′ of the coupling disk 1 is connected to one drive shaft 8 and the circumferentially following mounting piece 2 is connected to the other drive shaft 9 in alternation.

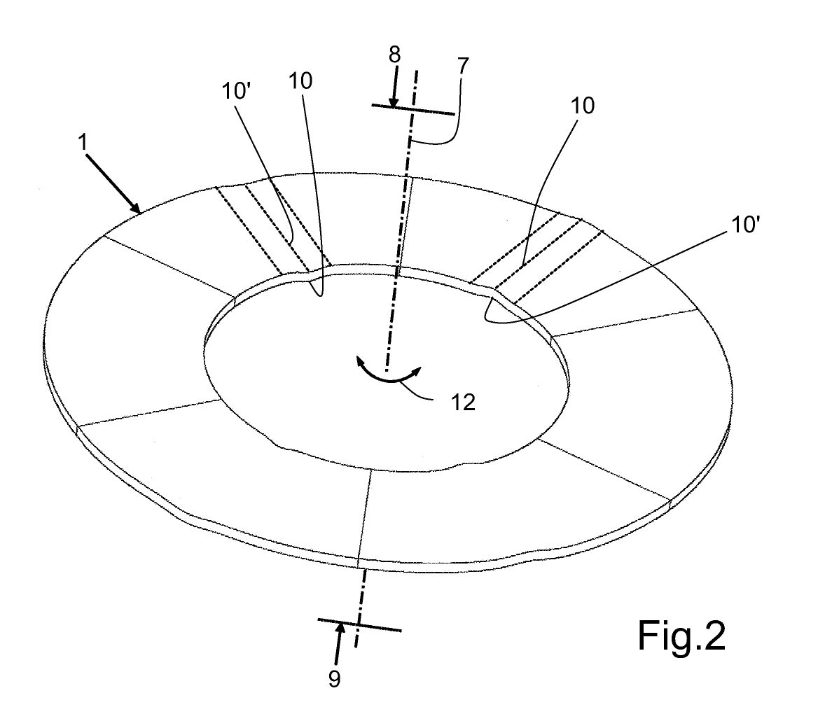

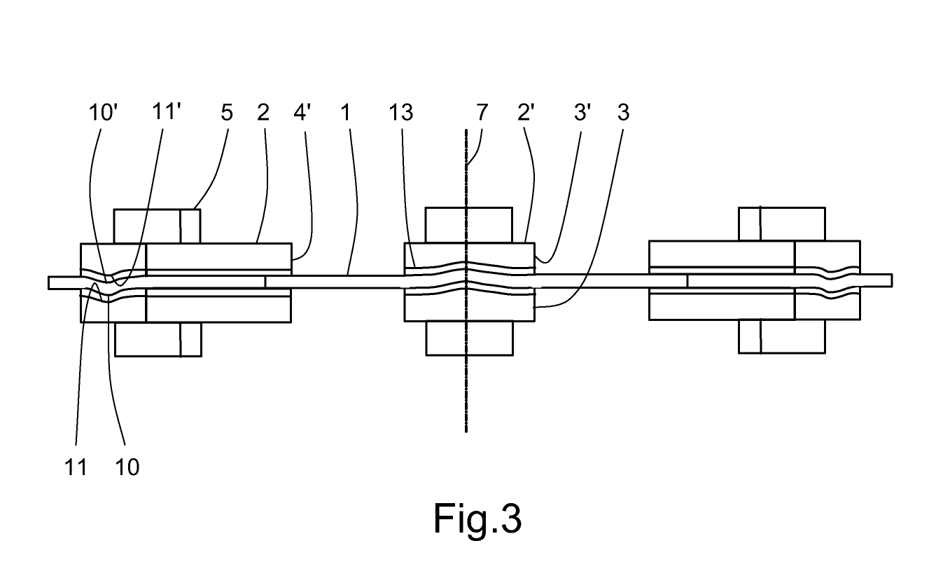

The coupling disk 1 is of corrugated designed in the regions of the mounting pieces 2, 2′. The corrugation of the coupling disk 1 is clearly visible in FIG. 2 and FIG. 3. Thus, the coupling disk 1 has corrugations 10, 10′ in the regions provided for mounting. The corrugations 10, 10′ project axially, parallel to the direction of the axis of rotation 7 of the coupling disk 1, as bulges out of the plane of the disk or, on the opposite side, as recesses into the plane of the disk and extend over the entire width of the ring in the radial direction. The bulges and recesses of the corrugations 10, 10′ are formed in circumferential alternation.

Corresponding corrugations 11, 11′ are formed as axial recesses and bulges on the mounting pieces 2, 2′, so that the undulating bulges and recesses of the coupling disk 1 and of the mounting pieces 2, 2′ are inserted positively into one another, as FIG. 3, in particular, illustrates.

By virtue of the positive engagement between the two drive shafts 8, 9 via the mounting pieces 2, 2′ and the coupling disk 1, the forces during torque transmission act on the flanks of the corrugations 10, 10′, 11, 11′ in the circumferential direction or the direction of rotation 12 of the coupling disk 1. The driving forces are transmitted from the first drive shaft 8, via the fastening for conjoint rotation of the first mounting pieces 2′ to said first drive shaft 8, through the coupling disk 1 and the fastening for conjoint rotation of the second mounting pieces 2 to the second drive shaft 9, to said second drive shaft 9. The elasticity of this connection is determined by the properties of the material of the coupling disk 1 and by the corrugation geometry of the coupling disk 1. During torque transmission between the drive shafts 8, 9, slightly flexing torsional vibrations and/or slight misalignments that arise are compensated by virtue of these elastic properties.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

### LIST OF REFERENCE SIGNS

1 coupling disk
2, 2′ mounting piece
3, 3′ plate of the mounting piece 2, 2′
4 radially outer end of the mounting piece 2′
4′ radially inner end of the mounting piece 2
5 flange portion of the mounting piece 2, 2′
6 receptacle, threaded hole
7 axis of rotation of the coupling disk
8 first drive shaft
9 second drive shaft
10, 10′ corrugations on the disk
11, 11′ corrugations on the mounting pieces
12 direction of rotation of the coupling disk
13 interlayer

1. An elastic coupling device for connecting two drive shafts having a coupling disk, which is arranged axially between and for conjoint rotation on a first drive shaft and a second drive shaft, wherein the coupling disk acts as a mechanical compensator during torque transmission between the two drive shafts characterized in that the coupling disk is retained without penetration by means of a plurality of circumferentially distributed mounting pieces wherein the mounting pieces can be connected to the first drive shaft or to the second drive shaft in circumferential alternation, and wherein the coupling disk and the mounting pieces are contoured parallel to the direction of the axis of rotation of the coupling disk in such a way that the mounting pieces fit at least partially positively around the coupling disk on respectively associated coupling sections, whereby the positive engagement is effective in the direction of rotation of the coupling disk.

2. The coupling device of claim 1, wherein the mounting pieces are designed as clamping elements, which can be pushed into positive engagement on the coupling disk in a preloaded manner.

3. The coupling device of claim 2 wherein the coupling disk is produced as a monolithic component composed of a fiber composite material.

4. The coupling device of claim 3, wherein the coupling disk composed of the fiber composite material has a defined fiber orientation.

5. The coupling device of claim 4 wherein the fibers in the coupling disk are arranged substantially in a circular or spiral pattern.

6. The coupling device of claim 3, wherein said fiber composite material includes fibers which are arranged in an identifiable pattern.

7. The coupling device of claim 1, wherein the coupling disk is designed as an annular disk and the mounting pieces are distributed in a circumferentially symmetrical manner and can be pushed into positive engagement on the coupling disk alternately from radially inside to radially outside and from radially outside to radially inside, and wherein the mounting pieces each include two plates in the form of ring segments, which are arranged opposite one another on both sides of the coupling disk and are connected to one another to form a U-shaped component formed so as to be solid or integral at one end radially on the outside of the coupling disk.

8. The coupling device of claim 7 wherein in order to connect the mounting pieces to the first drive shaft or to the second drive shaft, a flange-type or stud-type portion is provided in the region of the radially outer end of the mounting piece on one of the sides facing the drive shafts on which portion a connecting element, such as a stud bolt or a machine screw, can be secured or can be inserted or screwed non-rotatably into a corresponding recess or threaded hole.

9. The coupling device of claim 1, wherein in order to connect the mounting pieces to the first drive shaft or to the second drive shaft, a flange-type or stud-type portion is provided in the region of the radially outer end of the mounting piece on one of the sides facing the drive shafts on which portion a connecting element, such as a stud bolt or a machine screw, can be secured or can be inserted or screwed non-rotatably into a corresponding recess or threaded hole.

10. The coupling device of claim 1, wherein the coupling disk is of corrugated design, at least in the region of the mounting pieces, and the mounting pieces are each of a corrugated design and can be connected to the corrugated coupling disk on their surfaces facing the axial surfaces of the coupling disk.

11. The coupling device of claim 10, wherein the corrugation of the coupling disk is limited to corresponding elevations and/or depressions on the axial surfaces of the coupling disk or entirely traverses the coupling disk axially.

12. The coupling device as claimed in claim 11, wherein the mounting pieces are produced from a lightweight material.

13. The coupling device of claim 12 which further includes an elastically deformable interlayer which is in each case arranged axially between the mounting pieces and the coupling disk.

14. The coupling device of claim 1, wherein the mounting pieces are produced from a lightweight material

15. The coupling device of claim 1, which further includes an elastically deformable inter layer which is in each case arranged axially between the mounting pieces and the coupling disk.

16. The coupling device of claim 1 wherein the coupling disk is produced as a monolithic component comprised of a fiber composite material.

17. An elastic coupling device for connecting two shafts, said elastic coupling device comprising:
a coupling disk which is axially arranged between said two shafts, wherein said coupling disk includes a plurality of circumferentially distributed mounting pieces, wherein each mounting piece being contoured parallel to the direction of an axis of rotation of said coupling disk.
